(19) United States
(12) Patent Application Publication
(10) Pub. No.: US 2011/0210186 A1
(43) Pub. Date: Sep. 1, 2011

(54) MOBILE SPRAYER SYSTEM FOR SPRAYING AQUATIC ENVIRONMENTS

(76) Inventors: Lane Kugler, Lexington, NE (US); Chase Kugler, Lexington, NE (US)

(21) Appl. No.: 12/715,229

(22) Filed: Mar. 1, 2010

(51) Int. Cl. A01G 25/09; B05B 17/04

(52) U.S. Cl. 239/11; 239/146

(57) ABSTRACT

A mobile sprayer is provided for spraying through difficult terrain found in aquatic environments. The sprayer includes an amphibious vehicle equipped with a spray tank, a pump assembly connected to the spray tank, a plurality of spray nozzles, and a controller for selectively supplying fluid from the pump assembly to the spray nozzles. The sprayer has a rugged frame and boom assembly that allows multiple configurations of the sprayer to match the terrain in the environment to be sprayed. The controller is operable to individually operate multiple spray zones in each configuration of the sprayer so that any one spray zone or combination of spray zones can be covered during a spraying operation. The controller also includes a GPS receiver for providing path guidance to the sprayer, mapping of the area sprayed, and automatic adjustment of pressure at the spray nozzles based on speed for maintaining precise chemical application rates.

### BACKGROUND OF THE INVENTION

1. Field of the Invention

The present invention relates generally to sprayers for applying chemicals to outdoor areas, and in particular to sprayers and methods for applying chemicals through difficult terrain found in aquatic environments, such as river and wetland habitats.

2. Description of the Related Art

Invasive weeds, such as Phragmites, Saltcedar and Russian Olive, are choking the water-carrying capacity of many streams and rivers in the United States. Herbicides are a vital part of the solution for controlling these invasive weeds. However, conventional sprayers designed for agriculture use are not equipped to handle the difficult terrain found in these aquatic environments.

Aerial spraying has been used to apply herbicides to control invasive weeds in aquatic environments. Aerial spraying may be accomplished with either fixed wing aircraft or helicopters equipped with spray booms and spray nozzles that apply chemical from the air above the area being sprayed. However, aerial spraying often does not allow areas under trees, such as river and stream banks, to be sprayed, nor does it minimize over-spray to reduce unnecessary impact on the environment.

Boomless sprayers have been developed for use with ATVs and other off-road vehicles to allow spraying through rugged terrain, such as pastures and the like. These sprayers use spray nozzles having extra wide spray patterns so that spraying applications can be completed without the need for booms. These spray nozzles are available commercially under the name BOOM BUSTER™ from Evergreen Products, Inc. of Millen, Ga., and are described in U.S. Pat. No. 5,076,497.

Amphibious, tracked vehicles have been developed for traversing wetland environments. Such amphibious vehicles are available commercially under the name MARSH MASTER™ from Coast Machinery LLC in Baton Rouge, La.

There is a need for an improved sprayer and method for applying chemicals to aquatic environments.

### SUMMARY OF THE INVENTION

An object of the present invention is to provide a versatile sprayer capable of spraying in a wide variety of aquatic environments found near rivers and wetlands.

A further object of the present invention is to provide a mobile sprayer system that has multiple configurations for adapting to different aquatic environments and spraying conditions.

A further object of the present invention is to provide a sprayer suitable for use on an amphibious vehicle to spray invasive weeds found in aquatic environments and other difficult terrain.

Further objects of the present invention are to provide a spray system that: provides a fast, accurate application through rugged terrain; is cost effective and efficient in use; provides GPS mapping, GPS sprayer control, and GPS guidance; has efficient mobility; is fully amphibious to handle all wetland and upland terrain; has variable, multi-zone spraying swaths; and is capable of accurately spraying river and stream banks.

To accomplish these and other objects of the present invention, a mobile sprayer is provided for spraying through difficult terrain found in aquatic environments. The sprayer includes an amphibious vehicle equipped with a spray tank, a pump assembly connected to the spray tank, a plurality of spray nozzles, and a controller for selectively supplying fluid from the pump assembly to the spray nozzles. The sprayer has a rugged frame and boom assembly that allows multiple configurations of the sprayer to match the terrain in the environment to be sprayed. The controller is operable to individually operate multiple spray zones in each configuration of the sprayer so that any one spray zone or combination of spray zones can be covered during a spraying operation. The controller also includes a GPS receiver for providing path guidance to the sprayer, mapping of the area sprayed, and automatic adjustment of pressure at the spray nozzles based on speed for maintaining precise chemical application rates.

According to one aspect of the present invention, a mobile sprayer is provided for spraying aquatic environments, comprising: a self-propelled vehicle; a spray tank; a pump assembly connected to the spray tank; a plurality of spray nozzles; and a controller for selectively supplying fluid from the pump assembly to the spray nozzles. The spray nozzles of the mobile sprayer are arranged in a plurality of different configurations for accommodating different spraying conditions found in aquatic environments.

According to another aspect of the present invention, a method of spraying aquatic environments is provided, comprising: providing a sprayer comprising an amphibious vehicle equipped with a spray tank, a pump assembly connected to the spray tank, a plurality of spray nozzles, and a controller for selectively supplying fluid from the pump assembly to the spray nozzles; and configuring the sprayer into one of a plurality of possible spray configurations to match the nature of the terrain in the environment to be sprayed. The spray configurations include: (1) a first configuration in which an upper boom assembly having a center section and outer sections is in a raised position with the outer sections extending outwardly from the center section, adjustable outer nozzles are located at outer ends of the upper boom assembly, and center nozzles are located on a center section of the upper boom assembly; (2) a second configuration in which the outer sections of the upper boom assembly are folded inwardly and lowered with the center section remaining in a raised position, the adjustable outer nozzles are located at outer ends of the raised center section of the upper boom assembly, and a plurality of spray nozzles are located on a lower boom assembly for spraying a center zone between the adjustable outer nozzles; (3) a third configuration in which the outer sections of the upper boom assembly are folded inwardly and lowered with the center section remaining in a raised position, and the center nozzles located on the raised center section of the upper boom assembly are used for spraying; and (4) a fourth configuration in which the upper boom assembly is lowered into a stowed position and a plurality of spray nozzles located on the lower boom assembly are used for spraying.

Numerous other objects of the present invention will be apparent to those skilled in this art from the following description wherein there is shown and described an example embodiment of the present invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings.

In the drawings:

FIG. 1 is a side view of a mobile sprayer system for spraying aquatic environments according to the present invention, with the main spray boom in its raised position.

FIG. 2 is a view showing the controller inside the cab of the mobile spray system.

FIG. 3 is a rear view of the mobile sprayer system of the present invention, with the main spray boom in a first configuration for spraying.

FIG. 4 is a rear view of the mobile sprayer system of the present invention showing one outer section of the main spray boom folded inwardly to a narrow configuration, and a removable end nozzle assembly moved from the outer section to a center section of the main spray boom.

FIG. 5 is a detail view of an adjustable end nozzle assembly used in the sprayer system of the present invention.

FIG. 6 is a rear view of the mobile sprayer system of the present invention with both outer sections of the main spray boom folded inwardly, and the removable end nozzle assemblies attached to the center section of the main spray boom to provide a second configuration for spraying.

FIG. 7 is a rear view of the mobile sprayer system of the present invention with the outer boom sections of the main spray boom folded inwardly, and a back-to-back center nozzle assembly used to provide a third configuration for spraying.

FIG. 8 is a side view of the mobile sprayer system of the present invention with the main spray boom folded inwardly and downwardly into in its stowed position.

FIG. 9 is a rear view of the mobile sprayer system of the present invention with the main spray boom folded inwardly and lowered, and a lower spray boom used to provide a fourth configuration for spraying.

### DETAILED DESCRIPTION OF THE INVENTION

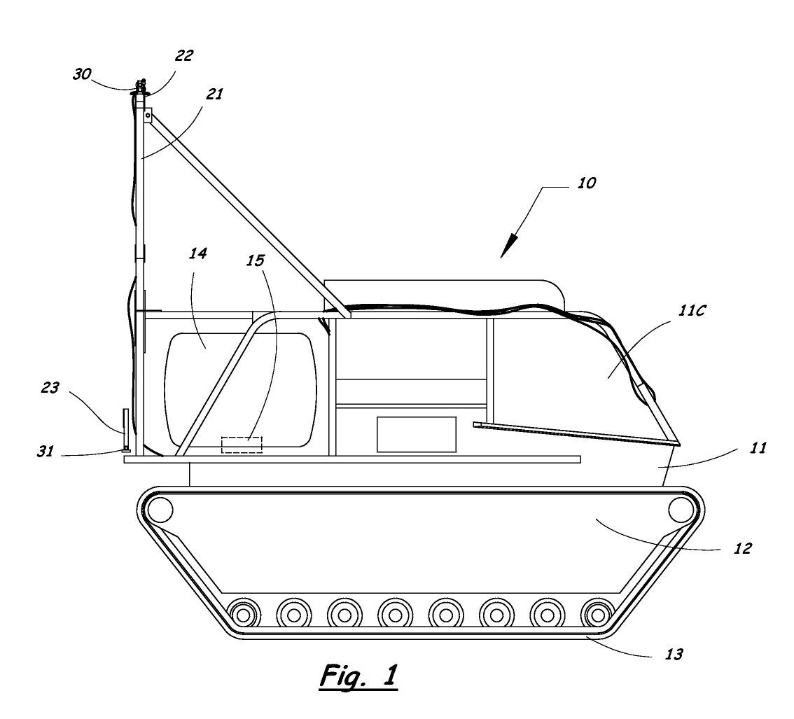

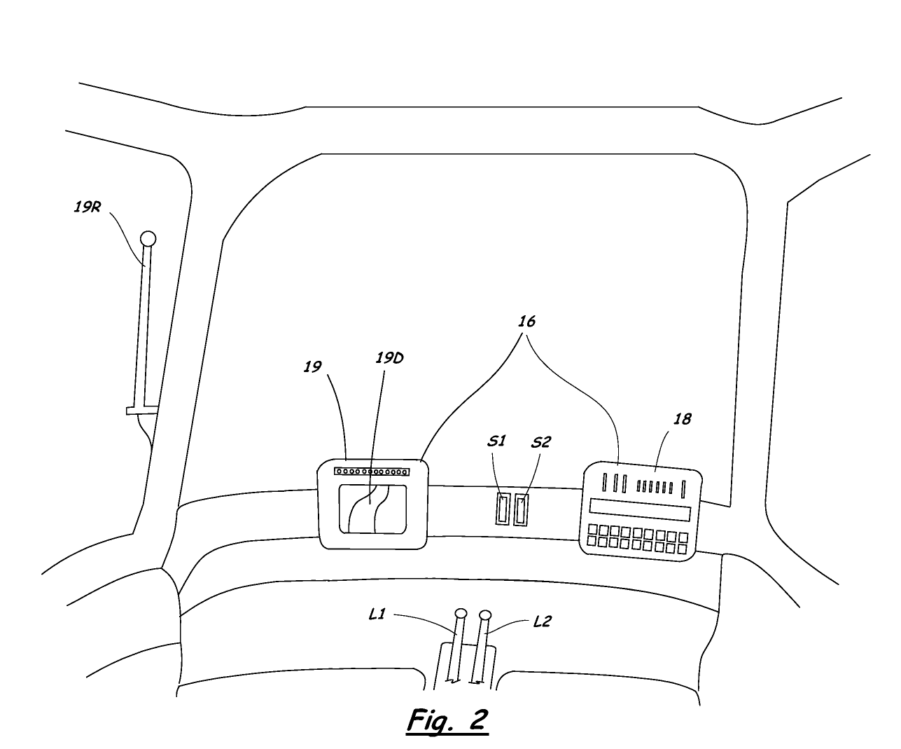

A mobile sprayer 10 for spraying aquatic environments according to the present invention will now be described in detail with reference to FIGS. 1 to 9 of the accompanying drawings.

The mobile sprayer 10 includes a self-propelled amphibious vehicle 11 capable of traveling through the difficult terrain typically found in and around rivers and wetlands and other aquatic environments. The amphibious vehicle 11 preferably includes a watertight body 12 that allows the vehicle 11 to float in deep water, and a track propulsion system 13 capable of climbing steep river banks and traversing muddy areas. In the illustrated embodiment, the vehicle 11 has two levers L1, L2 located between the seats to control the vehicle's motion and allow for one-handed driving from either seat (e.g., the left seat occupant can control the vehicle's motion with his/her right hand, and the right seat occupant can drive with his/her left hand). An amphibious vehicle sold under the proprietary name MARSH MASTER™ by Coast Machinery LLC in Baton Rouge, La., has been found to be a suitable vehicle 11 for use in the present invention.

The spray vehicle 11 is equipped with a spray tank 14 and a pump assembly 15 connected to the spray tank 14. The pump assembly 15 in the illustrated embodiment includes a hydraulic pump and valve assembly located under the spray tank 14. The spray vehicle 11 is also equipped with a spray controller 16 located in a cab 11C of the vehicle 11 for selectively supplying fluid from the pump assembly 15 to a plurality of spray nozzles 30, 31. The spray controller 16 includes a rate controller 18 and a mapping/guidance unit 19.

The rate controller 18 can be, for example, a computer-based controller that automatically adjusts pressure at the spray nozzles 30, 31 based on a detected ground speed of the sprayer 10 to maintain precise chemical application rates. Flow meters, pressure sensors, and control valves are provided in the plumbing between the spray tank 14, pump assembly 15, and spray nozzles 30, 31 and are used by the rate controller 18 to maintain the desired application rates and to provide selective on/off controls for various zones along the width of the sprayer 10. A rate controller available from Raven Industries Inc. and identified as Model SCS 440 has been found to be suitable for use in the present invention.

The mapping/guidance unit 19 can be, for example, a GPS-based unit that includes a GPS receiver 19R, a visual display 19D showing the area being sprayed, and a mapping function for mapping the area sprayed. The mapping/guidance unit 19 is connected to, or integral with, the rate controller 18 so that the GPS receiver can be used to provide a speed signal to the rate controller 18, and so that the settings and information detected by the rate controller 18 can be input to the GPS-based unit 19 for providing a live visual display and information for mapping the area sprayed. The GPS-based unit 19 can also be used to provide path guidance for the sprayer 10 using known GPS “last pass” technology. The data collected by the GPS-based unit 19 can be downloaded for GIS mapping to produce maps of what has been sprayed. A GPS-based unit available from Raven Industries Inc. and identified as the ENVIZIO PLUS model has been found to be suitable for use as the mapping/guidance unit 19 in the present invention.

The sprayer 10 has a boom assembly 21 that can be changed into multiple configurations to accommodate different spraying conditions found in aquatic environments. The boom assembly 21 includes an upper main boom assembly 22 and a lower secondary boom assembly 23. The upper main boom assembly 22 includes a center section 24, two outer sections 25, 26, and a support frame 27 for supporting the center section 24 and the outer sections 25, 26.

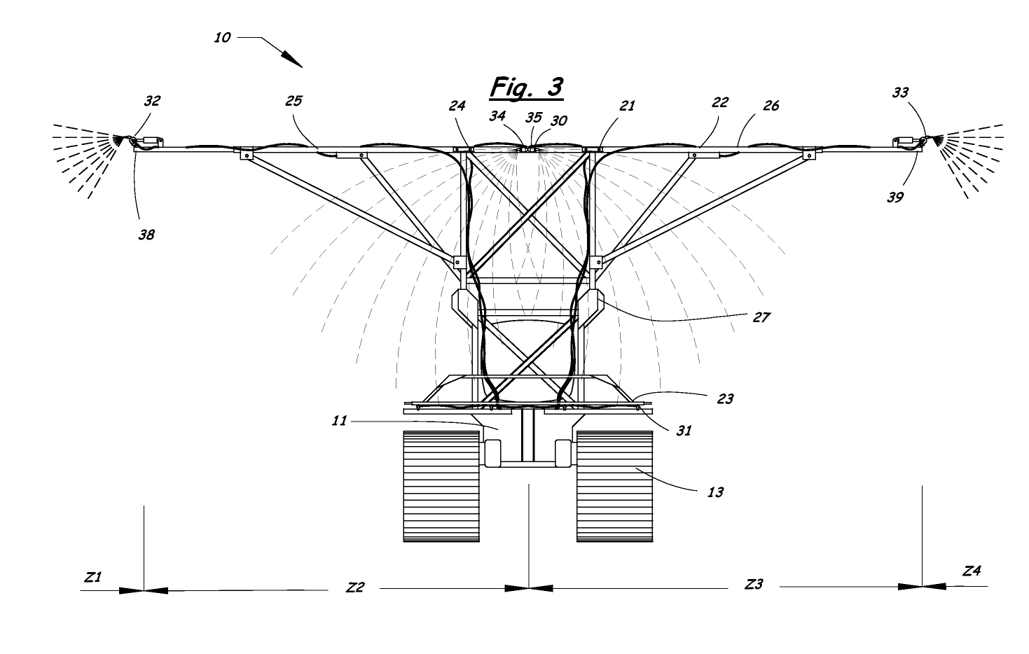

The support frame 27 for the upper boom assembly 22 can be reconfigured into multiple arrangements to provide three distinct positions for the upper boom assembly 22. The upper boom assembly 22 has a first position (shown in FIG. 3) in which the center section 24 and the outer sections 25, 26 are supported above the vehicle 11 and are fully extended outwardly. In this position, the center section 24 and outer sections 25, 26 of the upper boom assembly 22 are positioned at least 10 feet above the ground, and preferably at least 12 feet above the ground for spraying through stands of tall vegetation, such as Phragmites, Saltcedar and Russian Olive plants, found in river and wetland environments.

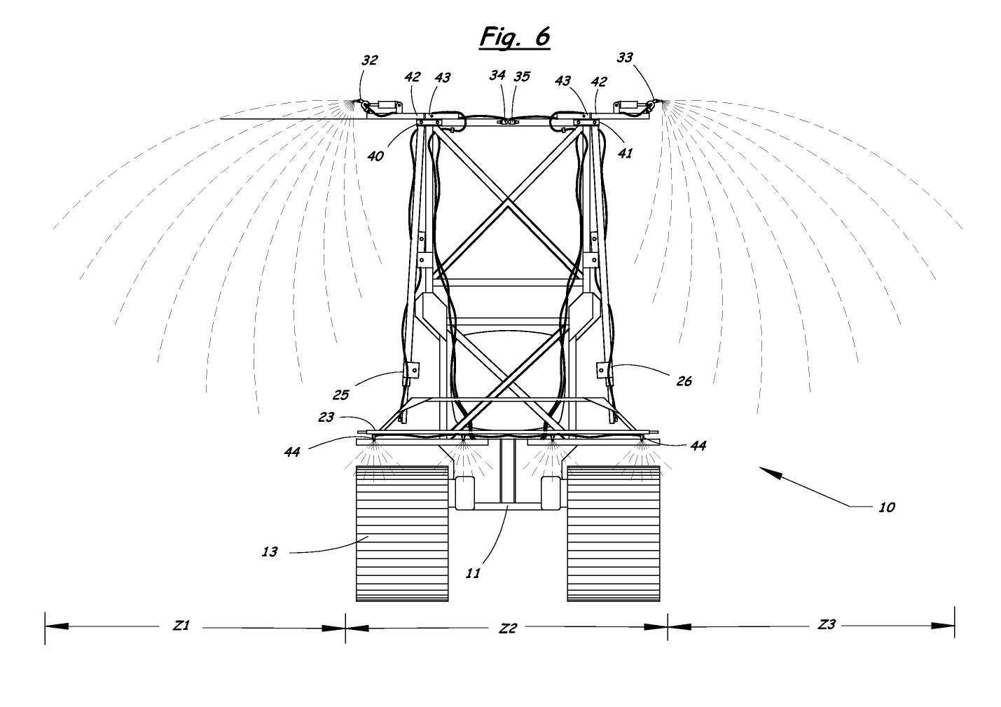

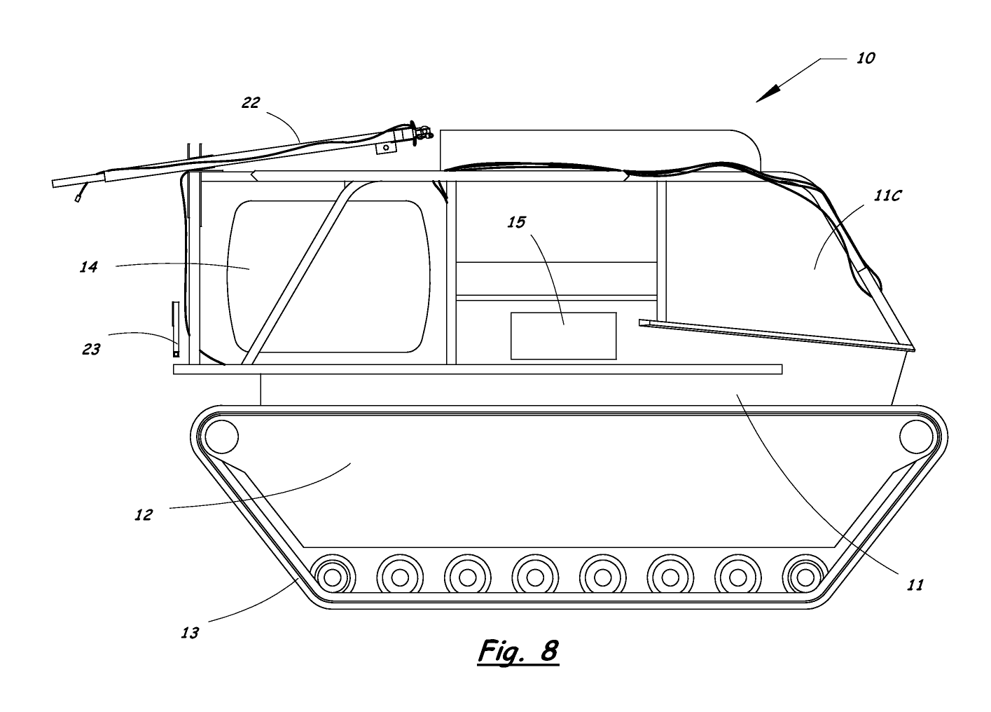

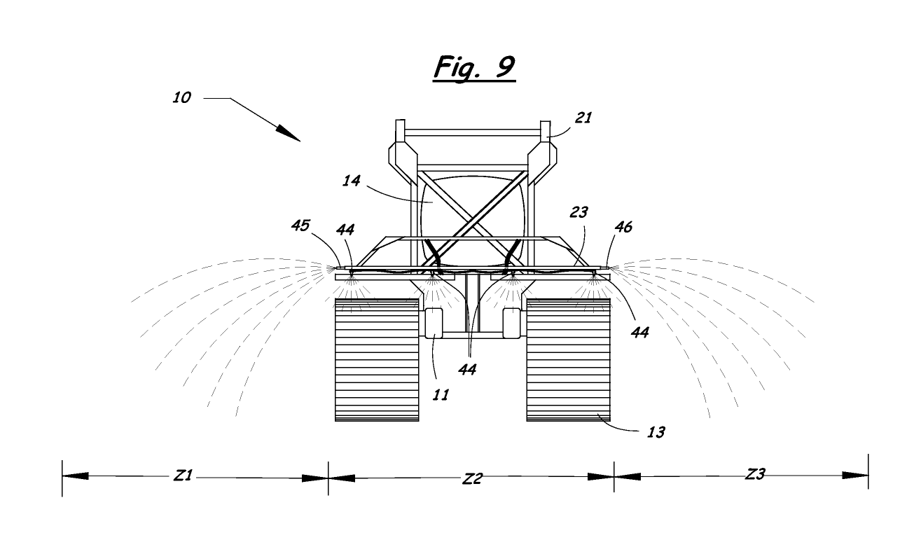

The upper boom assembly 22 has a second position (shown in FIG. 6) in which only the center section 24 is supported above the vehicle 11, and the outer sections 25, 26 are folded inwardly and lowered to provide a narrow spraying configuration. The upper boom assembly 22 has a third position (shown in FIGS. 8 and 9) in which the outer sections 25, 26 are folded inwardly, and both the center section 24 and the outer sections 25, 26 are lowered into a stowed position.

The spray nozzles for the sprayer 10 include a first group of nozzles 30 supported by the upper main boom assembly 22, and a second group of nozzles 31 supported by the lower secondary boom assembly 23. The first group of nozzles 30 includes first and second end nozzle assemblies 32, 33 and a pair of center nozzles 34, 35. The end nozzle assemblies 32, 33 and center nozzles 34, 35 each comprise a nozzle capable of projecting a spray pattern several feet outwardly while providing uniform coverage over the area of the zone being sprayed. Suitable nozzles for use in the end nozzle assemblies 32, 33 and as the center nozzles 34, 35 are available commercially under the name BOOM BUSTER™ from Evergreen Products Inc. of Millen, Ga.

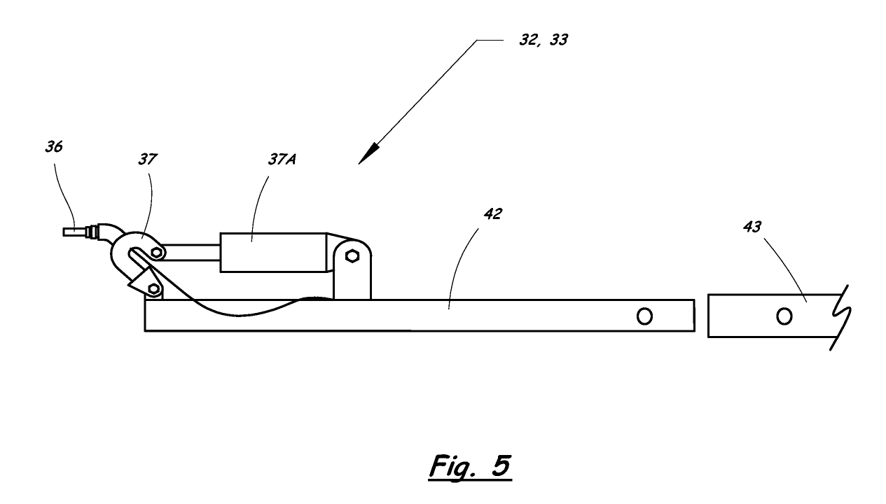

As shown in detail in FIG. 5, each end nozzle assembly 32, 33 includes a nozzle 36, a pivotally mounted support member 37, and an actuator 37A. The actuator 37A can be, for example, an electric or hydraulic-powered servo motor. Control switches S1, S2 in the cab of the vehicle 11 are provided to activate the actuators 37A. When the actuators are activated in one direction (e.g., extended), the support member 37 is pivoted to cause the nozzle 36 to be aimed downwardly. When the actuators are activated in the other direction (e.g., contracted), the support member 37 is pivoted to cause the nozzle 36 to be aimed upwardly. The control switches S1, S2 allow an operator in the cab of the vehicle 11 to adjust the vertical aim of the nozzles 36 of the end nozzle assemblies 32, 33 to provide an on-the-go adjustable spray pattern for spraying river banks and the like.

In a first configuration for spraying shown in FIG. 3, the first and second end nozzle assemblies 32, 33 are supported by the outer ends 38, 39 of the two outer sections 25, 26 of the upper main boom assembly 22. The center nozzles 34, 35 are positioned back-to-back at the middle of the center section 24 of the upper main boom assembly 22.

When using the first configuration for spraying, the spray controller 16 is set to open valves to supply spray fluid to the end nozzle assemblies 32, 33 and the pair of center nozzles 34, 35 to cover four spray zones Z1-Z4. The four spray zones include two outer zones Z1 and Z4 covered by the first and second end nozzle assemblies 32, 33, and two inner zones Z2 and Z3 covered by the pair of center nozzles 34, 35 supported by the center section 24. For example, the outer zones Z1 and Z4 can each be approximately 15 feet beyond the outer ends 38, 39 of the upper main boom assembly 22, and the inner zones Z2 and Z3 can each extend approximately 15 feet from the middle of the center section 24 out to the respective ends 38, 39 of the upper main boom assembly 22. In this example embodiment, the four zones Z1-Z4 in the first configuration provide a total spray width of approximately 60 feet.

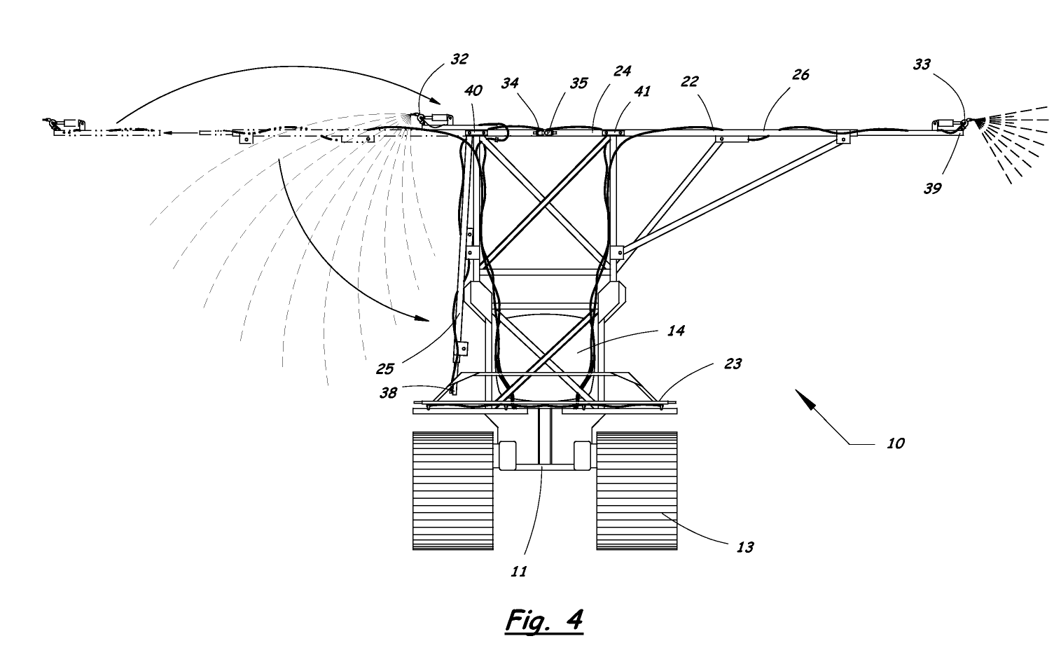

A second configuration for spraying, as shown in FIGS. 4 and 6, allows the sprayer 10 to operate in conditions that require a narrow boom assembly (e.g., lots of trees, hills, narrow streams, etc.). In the second configuration, the outer sections 25, 26 of the upper boom assembly 22 are folded inwardly to their stowed positions. The first and second end nozzle assemblies 32, 33 are removable from the two outer sections 25, 26 of the upper boom assembly 22 and attachable to the outer ends 40, 41 of the center section 24, as shown in FIG. 4. For example, the end nozzle assemblies 32, 33 can be supported by respective tubular members 42 that are attachable to receivers 43 located at the outer ends 40, 41 of the center section 24 and the outer ends 38, 39 of the outer sections 25, 26. The tubular members 42 can be secured in the receivers 43 using a pin member or other suitable fastener.

When using the second configuration for spraying, the spray controller 16 is set to open valves to supply spray fluid to the end nozzle assemblies 32, 33 (now attached to the outer ends 40, 41 of the center section 24 of the upper boom assembly 22) and to a center group 44 of the nozzles 31 supported by the lower boom assembly 23. There are three spray zones Z1-Z3 covered in the second configuration for spraying, including two outer zones Z1 and Z3 covered by the first and second end nozzle assemblies 32, 33 on the upper boom assembly 22, and a center zone Z2 covered by the center group 44 of the nozzles 31 on the lower boom assembly 23. For example, the outer zones Z1 and Z3 can each be approximately 15 feet beyond the outer ends 40, 41 of the center section 24 of the upper main boom assembly 22, and the inner zone Z2 can be approximately 10 feet wide to cover the area between the ends 40, 41 of the center section 24 of the upper main boom assembly 22. In this example embodiment, the three zones Z1-Z3 in the second configuration provide a total spray width of approximately 40 feet.

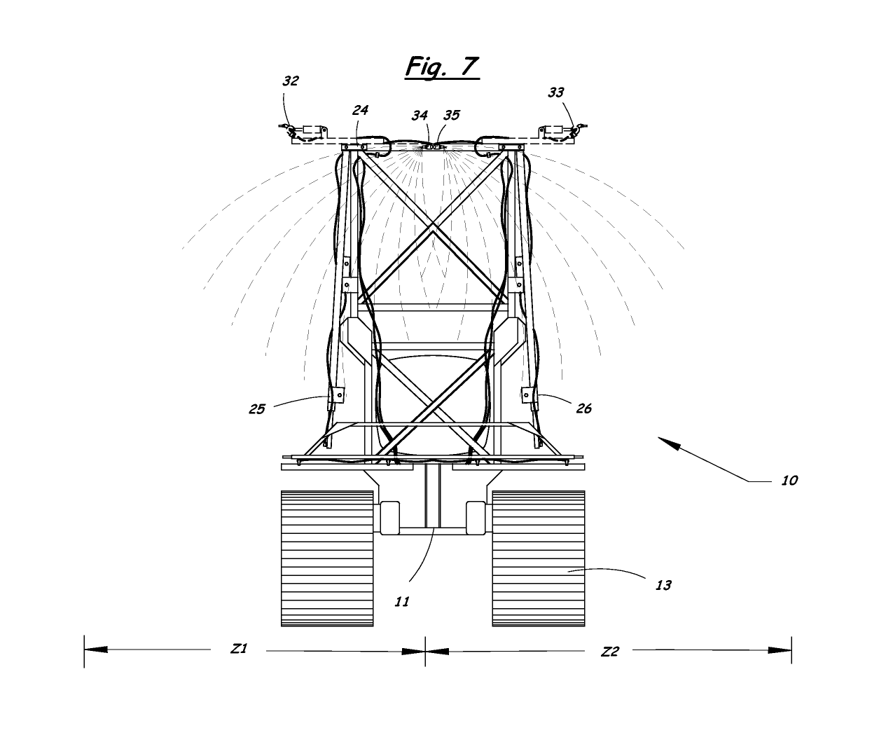

A third configuration for spraying, as shown in FIG. 7, provides another option for spraying in conditions that require a narrow boom assembly. In the third configuration, the pair of center nozzles 34, 35 supported by the center section 24 of the upper main boom assembly 22 are used for spraying. The outer sections 25, 26 of the upper main boom assembly 22 are folded inwardly to their stowed positions, and the end nozzle assemblies 32, 33 are either removed or just not operated.

When using the third configuration for spraying, the spray controller 16 is set to open valves to supply spray fluid to the center nozzles 34, 35. There are two spray zones Z1, Z2 covered in the third configuration for spraying, including a right side zone Z1 extending to the right of the center nozzle 34, and a left side zone Z2 extending to the left of the center nozzle 35. For example, each of the spray zones Z1, Z2 can extend 15 feet outwardly from a respective one of the center nozzles 34, 35 at the center of the sprayer 10 for a total spray width of approximately 30 feet.

A fourth configuration for spraying, as shown in FIGS. 8 and 9, provides an option for spraying in conditions that favor a low and narrow boom arrangement. In the fourth configuration, the lower secondary boom assembly 23 is used, and the upper main boom assembly 22 is folded inwardly and lowered into its stowed position. The nozzles 31 on the lower secondary boom assembly 23 include the center group of nozzles 44 and a pair of end nozzles 45, 46 arranged at the respective ends of the lower secondary boom assembly 23.

When using the fourth configuration for spraying, the spray controller 16 is set to open valves to supply spray fluid to the second group of nozzles 31 supported by the lower boom assembly 23. There are three zones Z1-Z3 covered in the fourth configuration for spraying, including two outer zones Z1, Z3 covered by the respective end nozzles 45, 46, and a center zone Z2 covered by the center group of nozzles 44 on the lower secondary boom assembly 23. For example, each of the outer zones Z1, Z3 can extend 15 feet outwardly from the respective outer ends of the lower secondary boom assembly 23, and the center zone Z2 can be approximately 10 feet wide to cover the area between the ends of the lower secondary boom assembly 23. In this example embodiment, the three zones Z1-Z3 in the fourth configuration provide a total spray width of approximately 40 feet.

The four spray configurations described above allow the sprayer 10 to be reconfigured and adapted to suit the wide variety of spray conditions encountered in aquatic environments. In each spray configuration, the controller 16 is operable to individually operate control valves associated with each spray zone separate from the other spray zones so that any one spray zone or combination of spray zones can be covered during a spraying operation. As mentioned above, the controller 16 also includes a GPS receiver 19 for providing path guidance to the sprayer 10, mapping of the area sprayed, and automatic adjustment of pressure at the spray nozzles 30, 31 based on speed for maintaining precise chemical application rates with minimal overlap.

A sprayer 10 according to the present invention has been described above. A method of using the sprayer 10 for spraying aquatic environments will now be described.

The method of using the sprayer 10 described above includes determining the nature of the terrain in the environment to be sprayed, and then configuring the sprayer 10 into one of a plurality of possible spray configurations to match the terrain. The operator can select from the following spray configurations:

(1) A first configuration (FIG. 3) in which the upper boom assembly 22 is in its raised position with the outer sections 25, 26 extending outwardly from the center section 24, adjustable outer nozzle assemblies 32, 33 are located at the outer ends 38, 39 of the upper boom assembly 22, and center nozzles 34, 35 are located on the center section 24 of the upper boom assembly 22;

(2) A second configuration (FIG. 6) in which the outer sections 25, 26 of the upper boom assembly are folded inwardly and lowered into a stowed position with the center section 24 remaining in its raised position, the adjustable outer nozzle assemblies 32, 33 are located at outer ends 40, 41 of the raised center section 24 of the upper boom assembly 22, and the center group 44 of spray nozzles 31 on the lower boom assembly 23 are used for spraying the zone between the adjustable outer nozzle assemblies 32, 33;

(3) A third configuration (FIG. 7) in which the outer sections 25, 26 of the upper boom assembly 22 are folded inwardly and lowered into a stowed position with the center section 24 remaining in its raised position, and the center nozzles 34, 35 located on the raised center section 24 of the upper boom assembly 22 are used for spraying; and

(4) A fourth configuration (FIG. 9) in which the entire upper boom assembly 22 is lowered into its stowed position, and the spray nozzles 31 located on the lower boom assembly 23 are used for spraying.

While the invention has been specifically described in connection with specific embodiments thereof, it is to be understood that this is by way of illustration and not of limitation, and the scope of the appended claims should be construed as broadly as the prior art will permit.

What is claimed is:

1. A mobile sprayer for spraying aquatic environments, comprising:
a self-propelled vehicle;
a spray tank;
a pump assembly connected to the spray tank;
a plurality of spray nozzles; and
a controller for selectively supplying fluid from the pump assembly to the spray nozzles;
wherein said spray nozzles are arranged in a plurality of different configurations for accommodating different spraying conditions found in aquatic environments.

2. The mobile sprayer according to claim 1, wherein said spray nozzles comprise a first group of nozzles supported by an upper main boom assembly, and a second group of nozzles supported by a lower secondary boom assembly.

3. The mobile sprayer according to claim 2, wherein said upper main spray boom assembly is positioned at least 10 feet above the ground in its first configuration for spraying.

4. The mobile sprayer according to claim 2, wherein said first group of nozzles comprises first and second end nozzle assemblies supported by the outer ends of the upper main boom assembly in a first configuration for spraying, said first and second end nozzle assemblies each comprising a nozzle and an actuator for adjusting the aim of the nozzle, said first and second nozzle assemblies providing an adjustable spray pattern for spraying river banks and the like.

5. The mobile sprayer according to claim 4, wherein said upper main boom assembly comprises a center section and two outer sections, said two outer sections being moveable between a folded-out position for spraying and a folded-in stowed position, and said first group of nozzles further comprises a pair of center nozzles supported by said center section for spraying a zone between said first and second end nozzle assemblies when the sprayer system is in its first configuration for spraying.

6. The mobile sprayer according to claim 5, wherein said first sprayer configuration comprises four spray zones, said four spray zones include two outer zones covered by said first and second end nozzle assemblies, and two inner zones covered by said pair of center nozzles supported by the center section.

7. The mobile sprayer according to claim 5, wherein said first and second end nozzle assemblies are removable from said two outer sections of the upper boom assembly and attachable to said center section to provide a second configuration for spraying when said outer sections are folded inwardly to their stowed positions.

8. The mobile sprayer according to claim 7, further comprising a second group of nozzles supported by said lower secondary boom assembly, said second group of nozzles being arranged for spraying a zone between said first and second end nozzle assemblies when the sprayer system is in its second configuration for spraying.

9. The mobile sprayer according to claim 8, wherein said second sprayer configuration comprises three spray zones, said three spray zones include two outer zones covered by said first and second end nozzle assemblies, and a center zone covered by the second group of spray nozzles supported by said lower secondary boom assembly.

10. The mobile sprayer according to claim 8, wherein said center nozzles supported by the center section of the upper main boom assembly are used to provide a third sprayer configuration for spraying when said outer sections of the upper main boom assembly are folded inwardly to their stowed positions.

11. The mobile sprayer according to claim 10, wherein said third sprayer configuration comprises two spray zones, said two spray zones include a right side zone covered by one of said center nozzles on the center section, and a left side zone covered by the other one of said center nozzles on the center section.

12. The mobile sprayer according to claim 2, wherein said upper main boom assembly comprises a center section, two outer sections, and a support frame for supporting the center and outer sections, said support frame having a first position in which the center and outer sections are supported above the self-propelled vehicle, a second position in which the center section is supported above the self-propelled vehicle with the outer sections folded inwardly and lowered, and a third position in which the outer sections and center section are folded inwardly and lowered into a stowed position.

13. The mobile sprayer according to claim 12, wherein said lower secondary boom assembly is arranged to provide a fourth configuration for spraying when the support frame of the upper main boom assembly is in its third position with the outer sections and the center section folded inwardly and lowered into a stowed position.

14. The mobile sprayer according to claim 13, wherein said fourth sprayer configuration comprises three spray zones, said three spray zones include two outer zones covered by respective end nozzles supported at the ends of the lower secondary boom assembly, and a center zone covered by a plurality of spray nozzles arranged between the respective end nozzles on the lower secondary boom.

15. The mobile sprayer according to claim 1, wherein said self-propelled vehicle comprises an amphibious vehicle capable of traveling through rivers and wetlands.

16. The mobile sprayer according to claim 1, wherein said self-propelled vehicle comprises a watertight body and a track propulsion system.

17. The mobile sprayer according to claim 1, wherein said controller comprises a control valve means for selectively supplying fluid to a plurality of spray zones in each of a plurality of sprayer configurations, wherein said control valve means includes a means for individually operating each spray zone separate from the other spray zones so that any one spray zone or combination of spray zones can be covered during a spraying operation.

18. The mobile sprayer according to claim 1, wherein said controller comprises a GPS receiver and means for providing path guidance to the sprayer, mapping of the area sprayed, and automatic adjustment of pressure at the spray nozzles based on signals received by the GPS receiver.

19. A method of spraying aquatic environments, comprising:
providing a sprayer comprising an amphibious vehicle equipped with a spray tank, a pump assembly connected to the spray tank, a plurality of spray nozzles, and a controller for selectively supplying fluid from the pump assembly to the spray nozzles; and
configuring the sprayer into one of a plurality of possible spray configurations to match the nature of the terrain in the environment to be sprayed, said spray configurations comprising:
a first configuration in which an upper boom assembly having a center section and outer sections is in a raised position with the outer sections extending outwardly from the center section, adjustable outer nozzles are located at outer ends of the upper boom assembly, and center nozzles are located on a center section of the upper boom assembly;
a second configuration in which the outer sections of the upper boom assembly are folded inwardly and lowered with the center section remaining in a raised position, the adjustable outer nozzles are located at outer ends of the raised center section of the upper boom assembly, and a plurality of spray nozzles are located on a lower boom assembly for spraying a center zone between the adjustable outer nozzles;
a third configuration in which the outer sections of the upper boom assembly are folded inwardly and lowered with the center section remaining in a raised position, and the center nozzles located on the raised center section of the upper boom assembly are used for spraying; and
a fourth configuration in which the upper boom assembly is lowered into a stowed position and a plurality of spray nozzles located on the lower boom assembly are used for spraying.

20. The method of spraying according to claim 19, wherein:
said first sprayer configuration comprises four spray zones, including two outer zones covered by said first and second end nozzle assemblies, and two inner zones covered by said pair of center nozzles supported by the center section;
said second sprayer configuration comprises three spray zones, including two outer zones covered by said first and second end nozzle assemblies, and a center zone covered by a plurality of spray nozzles supported by said lower secondary boom assembly;
said third sprayer configuration comprises two spray zones, including a right side zone covered by one of said center nozzles on the center section, and a left side zone covered by the other one of said center nozzles on the center section; and
said fourth sprayer configuration comprises three spray zones, including two outer zones covered by respective end nozzles supported at the ends of the lower boom assembly, and a center zone covered by a plurality of spray nozzles arranged between the respective end nozzles on the lower boom assembly.

21. The method of spraying according to claim 20, further comprising using a GPS receiver associated with the controller for providing path guidance to the sprayer during operation and for mapping an area sprayed by the sprayer.
